(19) United States
(12) Patent Application Publication
(10) Pub. No.: US 2015/0293030 A1
(43) Pub. Date: Oct. 15, 2015

(54) Sensor Array for Verifying the Condition of an Electronic Device

(71) Applicant: Tu Nguyen, Fremont, CA (US)

(72) Inventor: Tu Nguyen, Fremont, CA (US)

(21) Appl. No.: 14/470,641

(22) Filed: Aug. 27, 2014

Related U.S. Application Data
(63) Continuation-in-part of application No. 14/328,661, filed on Jul. 10, 2014.
(60) Provisional application No. 61/980,023, filed on Apr. 15, 2014.

(51) Int. Cl. G01N 21/88; G06Q 30/02; G06Q 10/00; G01N 21/47

(52) U.S. Cl. CPC G01N 21/8803; G01N 21/47; G01N 21/8851; G06Q 30/0278; G06Q 10/30; G01N 2021/8867; G01N 2201/062; G01N 2201/105

(57) ABSTRACT

A system and method for evaluating the cosmetic condition of a used electronic device, comprising directing one or more beams of light at the surface of the device and evaluating the amount of reflected light and the amount of scattered light off the surface of the device. The system and method can be used to evaluate the condition of the device or to confirm a user's manually entered evaluation of the device's condition.

### CROSS-REFERENCE TO RELATED APPLICATIONS

The present application is a continuation-in-part of application Ser. No. 14/328,661, filed Jul. 10, 2014, and takes priority from Provisional Application No. 61/980,023, filed Apr. 15, 2014, which is incorporated herein by reference.

### STATEMENT REGARDING FEDERALLY SPONSORED RESEARCH AND DEVELOPMENT

Not Applicable.

### BACKGROUND

1. Field of the Invention

The present invention relates generally to recycling electronic devices, and more particularly to a sensor array for verifying the condition of an electronic device.

2. Description of the Related Art

Due to the rapid evolution of electronic devices, consumers often have an excess of old, unwanted electronic devices cluttering up their homes. Such devices may include cell phones, PDA's, smartphones, GPS devices, calculators, mp3 players, and other similar electronics. While such devices may be worth money, it is often complicated to sell the devices, and too many of them end up thrown away. When thrown away, these devices contaminate the waste stream, due to their heavy metal content. This is a serious hazard to the environment.

To make recycling facilities more accessible to an average consumer, some companies make kiosks available for recycling or reselling used electronics. A consumer would put their device into a kiosk, which would identify the device, evaluate its condition, determine its value, and pay the consumer. Such kiosks can be made available in public places like supermarkets for easy accessibility.

One challenge that such kiosks face is the easy evaluation of a device's cosmetic condition (for example, “like new” versus “used” versus “cracked screen”). Many prior-art designs use cameras to image the device and determine its condition based on the images. This uses a lot of processing power and is very complex and expensive to implement.

A need therefore exists for an easy way to determine the cosmetic condition of an electronic device without using cameras.

### SUMMARY OF THE INVENTION

For purposes of the present disclosure, an “emitter” is any device capable of emitting radiation at any wavelength, ultrasonic waves at any wavelength, or any other radiation type that can reflect from the surface of a typical electronic device screen. In the preferred embodiment, the emitters are LED's. A “receiver” is any device capable of sensing the radiation emitted by the emitter.

For purposes of the present disclosure, “electronic device” is any mobile phone, mp3 player, tablet, gaming device, smartphone, or any similar device that can be recycled or resold.

An object of the present invention is to enable easy evaluation of the cosmetic condition of an electronic device without requiring a lot of processing power or complexity.

In its preferred embodiment, the present invention comprises at least one emitter that emits electromagnetic radiation onto at least one surface of an electronic device, and two receivers positioned in such a way that one receiver (the reflection receiver) receives radiation reflected off the surface of the device, and one receiver (the scattering receiver) receives radiation scattered by the surface of the device. The amounts of reflected vs. scattered radiation are then used to evaluate the cosmetic condition of the device. Preferably, the emitters and receivers are arranged in a linear, rectangular, or other types of array. The measurements can be made at two or more locations on the surface of the device and compared.

In the preferred embodiment, the emitters and receivers are then moved over the entire surface of the device (or the device is moved under the emitters and receivers), and the average value and standard deviation are calculated for both reflected and scattered radiation. The amount of standard deviation is then used to evaluate the cosmetic condition of the device; if the standard deviation is low, the cosmetic condition is presumed to be better, and if it is high, the cosmetic condition is presumed to be worse. Preferably, there are three categories of cosmetic condition—“Like New”, “Used”, and “Cracked”.

The emitters can emit a single wavelength of radiation or a broad spectrum. In an embodiment, some emitters emit radiation of different wavelengths.

In an embodiment, some of the emitters emit radiation at a different angle of incidence to the surface of the device than other emitters. In another embodiment, some of the emitters emit radiation at a different distance from the surface of the device than other emitters. In another embodiment, the emitters emit radiation at different intensities at different times.

While in the preferred embodiment, the evaluation is performed by calculating the average and standard deviation for the reflected and scattered radiation, the evaluation may also be performed by comparing the reflected and scattered radiation values with the reflected and scattered radiation values for a new device of the same brand and model.

### BRIEF DESCRIPTION OF THE SEVERAL VIEWS OF THE DRAWINGS

FIG. 1 shows the basic principle of the present invention.

FIGS. 2A-2D show some variations in the arrangement of emitters and receivers for the present invention.

FIG. 3 shows the preferred embodiment of the present invention being used to scan an electronic device.

FIG. 4 shows some variations in the arrangement of emitters and receivers for the present invention.

FIG. 5 shows a sample scan of an electronic device.

### DETAILED DESCRIPTION OF THE PREFERRED EMBODIMENT

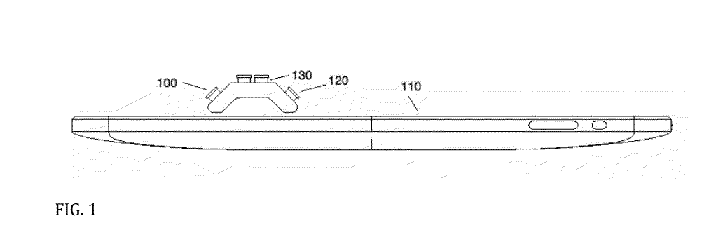

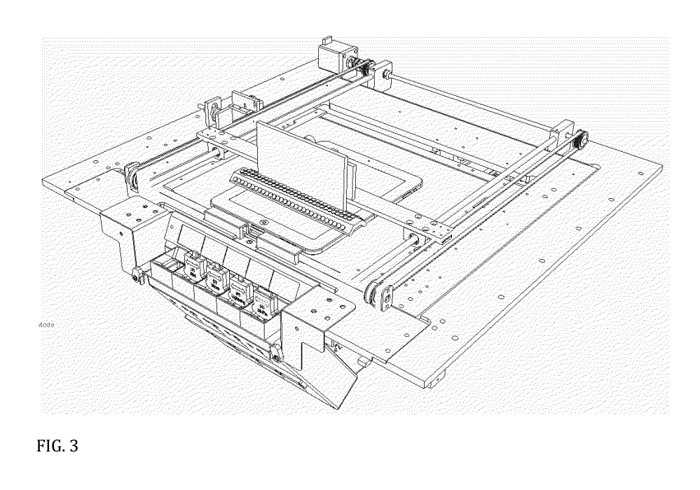

In its preferred embodiment, as shown in FIG. 1, the present invention comprises an array of emitters 100 positioned in such a way as to emit radiation at an angle onto an electronic device 110, and two arrays of receivers—one array of reflection receivers 120 positioned in such a way as to receive reflected radiation from the screen of the electronic device 110, and one array of scattering receivers 130 positioned in such a way as to receive scattered radiation from the screen of the electronic device 110. When emitters 100 shine onto the screen of the electronic device 110, reflection receivers 120 receive radiation reflected from the surface of the electronic device and scattering receivers 130 receive any radiation scattered by imperfections on the surface of the electronic device. In the preferred embodiment, the arrays of emitters, reflection receivers, and scattering receivers are linear arrays approximately the same length as, or greater than, the width of a typical electronic device. The linear arrays are then moved across the surface of the electronic device (or the electronic device is moved across the linear array) in such a way that the emitters and receivers scan the entire surface of the electronic device. In the preferred embodiment, the linear arrays are mounted on an arm that slides on rails perpendicular to its length, as shown in FIG. 3.

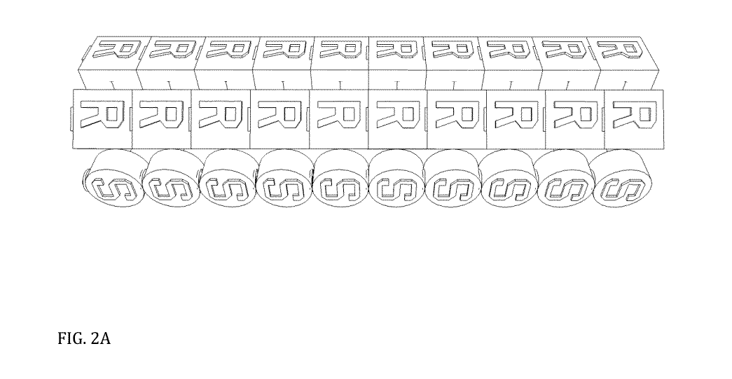

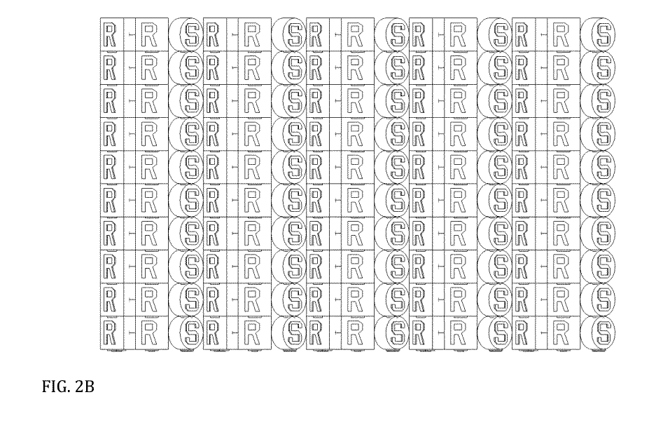

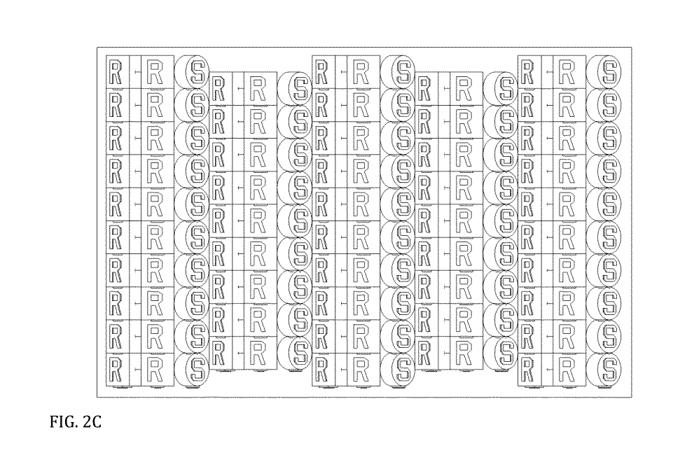

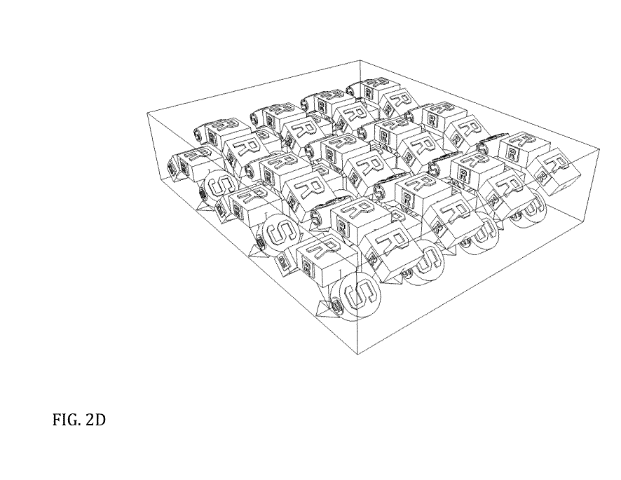

The arrays of emitters, reflection receivers, and scattering receivers can be any type of arrays—linear arrays, staggered arrays, two-dimensional arrays, or three-dimensional arrays. Some of the variations are shown in FIG. 2, and other variations will be apparent to those skilled in the art. For example, the arrays may be two-dimensional rectangular arrays of a size that covers all or part of the surface of the electronic device. The arrays may be triangular or any other shape, and may be moved over the surface of the electronic device by means of various mechanisms.

The emitters may be positioned in such a way that some of the emitters emit radiation at a different angle to the surface of the device than other emitters. This ensures that small imperfections in the surface of the electronic device get noticed. If a small scratch does not scatter enough radiation when illuminated at a particular angle, it may scatter much more radiation when illuminated at a different angle, and thus, may be much more noticeable.

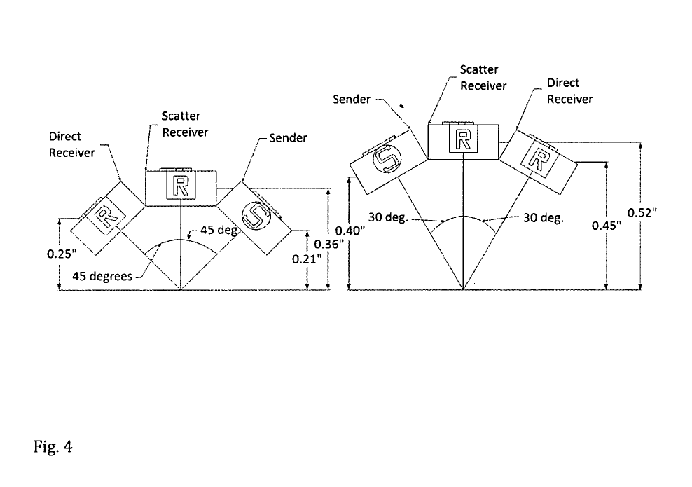

In an embodiment, some of the emitters are located at a higher elevation than other emitters, as shown in FIG. 4. In another embodiment, some of the receivers are located at a higher elevation than other receivers. In another embodiment, some receivers are placed in a position that would enable them to capture radiation reflected off the top of the surface of the device, whereas other receivers are placed in a position that would enable them to capture radiation reflected off the bottom of the glass cover of the device. This helps the system of the present invention detect more imperfections.

In an embodiment, some of the emitters emit different wavelength radiation from other emitters. Some imperfections in the surface of an electronic device may scatter more light at one wavelength than at a different wavelength. Detecting the scattering of light at different wavelengths helps the system of the present invention detect more imperfections.

In an embodiment, the emitters may emit radiation of different intensity—either the same emitters may emit different intensity radiation at different times, or different emitters may emit different intensity radiation. Detecting the scattering of light at different intensities helps the system of the present invention detect more imperfections.

The emitters may be any light-emitting devices known in the art, or devices that emit infrared or ultraviolet radiation, or radiation at any wavelength. Infrared LED's are preferable, but ultrasonic emitters are also possible in an embodiment of the invention. The receivers may be any type of receiver known in the art of receiver design, as long as the receiver is capable of registering the radiation emitted by the emitters.

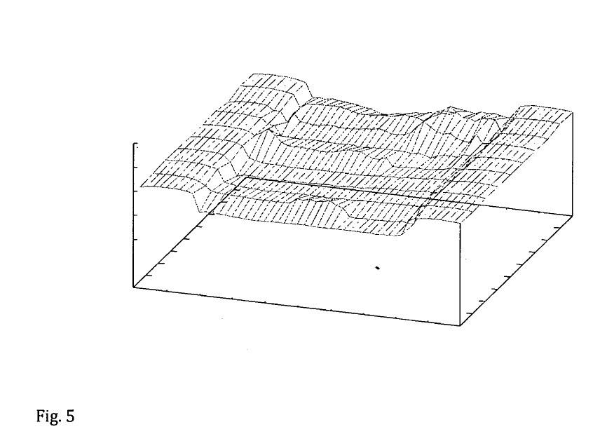

The preferred method of use for the device is to pass the array shown in FIG. 1 (or FIG. 2, or any other variation) over the screen of an electronic device as shown in FIG. 3. As the array passes over the screen, the reflected radiation and scattered radiation are analyzed. A sample scan result is shown in FIG. 5. Since every electronic device is different and the amount of reflectivity in the screen is different, the preferred embodiment uses a relative smoothness measurement to evaluate the condition of the device. The average value and standard deviation are calculated for both the reflection values and the scattering values, and used to evaluate the device.

If the reflection receivers and scattering receivers register a consistent amount of radiation throughout the pass, this would imply that the surface of the device is smooth and free of imperfections and the device can be classified as “Like New”. The less consistent the amount of radiation registered by the receivers, the more imperfections are implied to be on the surface of the device. If the device screen is cracked, the receiver readings will be very inconsistent, and the device can be classified as “Broken”. If the receiver readings are mildly inconsistent, the device can be classified as “Used”. The boundaries between “Like New”, “Used”, and “Broken” can be set by the manufacturer or by the installer of the device.

While in the preferred embodiment, to simplify computations, only three gradations of devices are used—“Like New”, “Used”, and “Broken” -other embodiments may use different categories or different numbers of categories. For example, the categories could be “Like New”, “Lightly Used”, “Heavily Used”, “Small Cracks” and “Large Cracks”.

Other embodiments may also exist. For example, the reflectivities of different types of devices may be stored in memory and the receiver readings may be compared with the typical readings for a new, used, or broken device of that particular type.

In an embodiment, the present invention may only scan a small part of the device screen, merely to confirm the condition that a user enters into the system ahead of time. For example, a user may designate their device as “Like New”. If a small part of the screen shows a nonzero amount of scattered radiation, the condition the user designates is not accepted. This saves time, technical complexity, and processor power.

The present invention is preferably installed in an automated kiosk for recycling used electronic devices. In such a kiosk, a user deposits a used electronic device, the used electronic device is evaluated by the module of the present invention and also possibly by other modules, and the user is paid for the electronic device. In other embodiments, the present invention may be installed in a retail-countertop device that assists a salesperson in determining a good value for a used electronic device, or in a testing module on the factory floor at a recycling facility.

While the preferred embodiment of the invention is described above, it will be clear to those skilled in the art that other embodiments of the invention are also possible without departing from the spirit or scope of the invention.

1. A module for verifying the cosmetic condition of an electronic device, comprising:
at least one emitter for emitting electromagnetic radiation of a first wavelength onto at least one surface of the electronic device;
at least one reflection receiver, said reflection receiver capable of sensing electromagnetic radiation of a first wavelength, said reflection receiver positioned in such a way as to sense electromagnetic radiation emitted by the emitter and reflected from the at least one surface of the electronic device;
at least one scattering receiver, said scattering receiver capable of sensing electromagnetic radiation of a first wavelength, said scattering receiver positioned in such a way as to sense electromagnetic radiation emitted by the emitter and scattered by the at least one surface of the electronic device;
a processor that is configured to receive data from the at least one reflection receiver and the at least one scattering receiver and evaluate the data.

2. The module of claim 1, further comprising:
a scanning mechanism for moving the at least one emitter, at least one reflection receiver, and the at least one scattering receiver to at least a first location and a second location on the at least one surface of the electronic device.

3. The module of claim 1, further comprising:
a scanning mechanism for moving the electronic device with respect to the at least one emitter, at least one reflection receiver, and at least one scattering receiver.

4. The module of claim 2, comprising an array of emitters, an array of reflection receivers, and an array of scattering receivers, where the scanning mechanism moves the arrays in such a way as to cover the entire surface of the electronic device.

5. The module of claim 4, wherein the arrays are linear arrays of a length equal or greater to the width of the electronic device, and wherein the scanning mechanism moves the linear arrays in such a way as to cover the entire surface of the electronic device.

6. The module of claim 4, wherein the processor is configured to compare the data received from the reflection receivers and the scattering receivers at a first location on the surface of the electronic device with the data received from the reflection receivers and the scattering receivers at a second location on the surface of the electronic device.

7. The module of claim 4, wherein the processor is configured to evaluate the percentage of reflected electromagnetic radiation and the percentage of scattered electromagnetic radiation.

8. The module of claim 1, further comprising:
at least one secondary emitter for emitting electromagnetic radiation of a second wavelength onto at least one surface of the electronic device;
at least one secondary reflection receiver, said reflection receiver capable of sensing electromagnetic radiation of a second wavelength, said secondary reflection receiver positioned in such a way as to sense electromagnetic radiation emitted by the secondary emitter and reflected from the at least one surface of the electronic device;
at least one secondary scattering receiver, said secondary scattering receiver capable of sensing electromagnetic radiation of a second wavelength, said secondary scattering receiver positioned in such a way as to sense electromagnetic radiation emitted by the second emitter and scattered by the at least one surface of the electronic device.

9. The module of claim 1, wherein the emitters emit a broad spectrum of electromagnetic radiation.

10. The module of claim 1, wherein the emitters emit electromagnetic radiation of a first intensity at a first time, and electromagnetic radiation of a second intensity at a second time.

11. The module of claim 1, wherein at least one emitter emits electromagnetic radiation onto the surface of the electronic device at a first angle of incidence, and at least one other emitter emits electromagnetic radiation onto the surface of the electronic device at a second angle of incidence.

12. A method of evaluating the cosmetic condition of an electronic device, comprising:
emitting electromagnetic radiation of a first wavelength onto a first location of at least one surface of the electronic device;
measuring electromagnetic radiation reflected off the first location of the at least one surface of the electronic device;
measuring electromagnetic radiation scattered off the first location of the at least one surface of the electronic device;
evaluating the cosmetic condition of the electronic device.

13. The method of claim 12, further comprising:
emitting electromagnetic radiation of a first wavelength onto a second location of at least one surface of the electronic device;
measuring electromagnetic radiation reflected off the second location of the at least one surface of the electronic device;
measuring electromagnetic radiation scattered off the second location of the at least one surface of the electronic device;
comparing data received at the first location with data received from the second location;
evaluating the cosmetic condition of the electronic device using the data.

14. The method of claim 13, wherein these steps are performed at a plurality of locations on the surface of the electronic device in such a way as to cover the entire surface of the electronic device.

15. The method of claim 14, further comprising:
calculating the average value for reflected radiation;
calculating the average value for scattered radiation;
calculating the standard deviation for reflected radiation;
calculating the standard deviation for scattered radiation.

16. The method of claim 14, wherein:
the electronic device is evaluated as “Like New” if the standard deviation for reflected radiation and the standard deviation for scattered radiation do not exceed 10%.
the electronic device is evaluated as “Used” if the standard deviation for reflected radiation and the standard deviation for scattered radiation are between 10% and 40%;
the electronic device is evaluated as “Cracked” if at least one of the standard deviation for reflected radiation and the standard deviation for scattered radiation are higher than 40%.

17. The method of claim 12, further comprising:
emitting electromagnetic radiation of a second wavelength onto a first location of at least one surface of the electronic device;
measuring electromagnetic radiation reflected off the first location of the at least one surface of the electronic device;
measuring electromagnetic radiation scattered off the first location of the at least one surface of the electronic device;
comparing data received with the first wavelength with data received with the second wavelength;
evaluating the cosmetic condition of the device using the data.

18. The method of claim 12, further comprising:
performing the same steps for all other surfaces of the electronic device.

19. The method of claim 12, wherein the evaluating step comprises:
determining the brand and model of the electronic device;
comparing the data received from the measuring steps with stored values for the data from a new electronic device of the same brand and model.

20. An automated kiosk for recycling used electronic devices, comprising the module of claim 1.

21. A desktop device for recycling used electronic devices, comprising the module of claim 1.

22. A test fixture for used electronic devices, comprising the module of claim 1.
